(19) United States
(12) Patent Application Publication
(10) Pub. No.: US 2026/0204062 A1
(43) Pub. Date: Jul. 16, 2026

(54) SECURITY SYSTEM WITH EXPLAINABLE FALSE POSITIVES

(71) Applicant: TurbineOne, Inc., San Francisco, CA (US)

(72) Inventors: Tyler Moore, Colorado Springs, CO (US); Daniel Hebb, San Diego, CA (US); Joshua Harrison, Boulder, CO (US); Sandeep Mittal, Garner, NC (US)

(21) Appl. No.: 19/025,661

(22) Filed: Jan. 16, 2025

(51) Int. Cl. G06V 10/98; G06V 10/25; G06V 10/764; G06V 10/774; G06V 10/776

(52) U.S. Cl. CPC G06V 10/987; G06V 10/25; G06V 10/764; G06V 10/774; G06V 10/776

(57) ABSTRACT

A security system detects objects using a machine learning model. A first object detection model trained to detect a target object is applied to an image. The model also outputs a class activation map (CAM) for the image. An overlay image is generated based on the CAM. If the target object is determined to be depicted in the image, user feedback of a first metric of accuracy of the first object detection model is requested. A CAM score representative of a second metric of accuracy is generated using the user feedback. A model score is determined using the CAM score and used to compare with a model score of a second object detection model. A recommendation is made to apply one of the first or second object detection models based on the comparison.

### TECHNICAL FIELD

The present disclosure relates to security systems. In particular, the present disclosure relates to machine learning-driven object detection in security systems.

### BACKGROUND

Security systems are critical to detecting real-time threats to safety. Machine learning can enable automated object detection. However, machine learning models may not be as reliable as a human in accurately identifying security threats. To remedy this inaccuracy, machine learning models can be re-trained to improve accuracy. Re-training, however, is very processor and time intensive. A model can take hours to re-train, and in that time, security threats are being incorrectly identified and in turn, the safety of individuals and valuable property are at risk. Thus, re-training a machine learning model to maintain accuracy for detecting real-time security threats is challenging because of the large amount of time and processing resources needed.

### SUMMARY

A security system implements an object detection model and class activation mapping. The security system generates a class activation map (CAM) overlay with sensor images or video when presenting object detection results. The overlay provides a user with an explanation for a given detection, particularly if the detection is a false positive. In addition to helping users better understand a model's behavior, the security system improves the accuracy of object detections in various ways. The security system calculates a CAM score to determine how to improve object detection accuracy, where the CAM score is calculated based on the CAM overlay. The security system can use the CAM score to efficiently train an object detection model or select a model having higher accuracy among multiple models.

A method, non-transitory computer-readable storage medium, and computer system are disclosed for detecting a target object using an object detection model and making a recommendation to apply a particular object detection model. A first object detection model is applied to an image. The first object detection model is trained to detect the target object and output a CAM for the image. An overlay image is generated based on the image and the CAM. Responsive to a determination that the target object is depicted in the image, a first notification is caused to be generated at a client device. The first notification may include the overlay image and a request for user feedback representative of a first metric of accuracy of the first object detection model. A CAM score is generated using the user feedback, where the CAM score is representative of a second metric of accuracy of the first object detection model. A model score is determined, using the CAM score, for the first object detection model and compared to a model score of a second object detection model also trained to detect the target object. A second notification is caused to be generated at the client device, where the second notification includes a recommendation to apply one of the first object detection model or the second object detection model based on the comparison.

### BRIEF DESCRIPTION OF THE DRAWINGS

The disclosure will be understood more fully from the detailed description given below and from the accompanying figures of embodiments of the disclosure. The figures are used to provide knowledge and understanding of embodiments of the disclosure and do not limit the scope of the disclosure to these specific embodiments. Furthermore, the figures are not necessarily drawn to scale.

Figure (FIG. 1 illustrates a block diagram of an example system environment in which a security system operates, in accordance with one embodiment.

FIG. 2 depicts a block diagram of the security system, in accordance with one embodiment.

FIG. 3 shows a block diagram of an example process for generating the vector database of the security system, in accordance with one embodiment.

FIG. 4 depicts an example process for determining to prompt a user for additional training data for the object detection model(s), in accordance with one embodiment.

FIG. 5 depicts example graphical user interfaces (GUIs) that include notifications generated by the security system, in accordance with one embodiment.

FIG. 6 depicts a flowchart of an example process for selecting a model of the machine learning models of the security system, in accordance with one embodiment

FIG. 7 depicts a flowchart of an example process for re-training a machine learning model of the security system, in accordance with one embodiment.

FIG. 8 is a block diagram illustrating components of an example machine able to read instructions from a machine-readable medium and execute them in a processor (or controller).

### DETAILED DESCRIPTION

The Figures (FIGS.) and the following description relate to preferred embodiments by way of illustration only. It should be noted that from the following discussion, alternative embodiments of the structures and methods disclosed herein will be readily recognized as viable alternatives that may be employed without departing from the principles of what is claimed.

Reference will now be made in detail to several embodiments, examples of which are illustrated in the accompanying figures. It is noted that wherever practicable similar or like reference numbers may be used in the figures and may indicate similar or like functionality. The figures depict embodiments of the disclosed system (or method) for purposes of illustration only. One skilled in the art will readily recognize from the following description that alternative embodiments of the structures and methods illustrated herein may be employed without departing from the principles described herein.

### Overview

Aspects of the present disclosure relate to machine learning-driven object detection. A security system uses a machine learning model to implement class activation mapping. The security system generates a class activation map (CAM) overlay with sensor images or video when presenting object detection results. The security system calculates a CAM score based on the CAM overlay. The security system can use the CAM score to improve the accuracy of the object detection, determining how to target model re-training on particular images and/or select a model having higher accuracy among multiple models.

The security system can use the CAM score to determine which types of training images would improve the accuracy of a model's object detection and instruct the user to provide a particular type of image for targeted training. The security system may identify, using the CAM score, that an object detection model trained to detect first and second target objects detects a first target object with higher accuracy than the model detects the second target object. In response, the security system can determine that more images of the second target object or images of the second target object at different angles, backgrounds, etc. are likely to improve the accuracy of the model upon re-training. The security system may score, using the CAM score, object detection models and select a model having a higher detection accuracy. For example, the security system scores object detection models that detect the same target object and recommends the user select one having higher accuracy for detecting that target object.

### Example System Environment

Figure (FIG. 1 illustrates a block diagram of an example system environment 100 in which a security system 110 operates, in accordance with one embodiment. The system environment 100 includes a security system 110, one or more sensors 120a-n (n corresponding to outer number of sensors; generally sensor 120), one or more client devices 130a-n (n corresponding to outer number of client devices; generally n (n corresponding to outer number of sensors; generally client device 130), and a network 140 (which itself may comprise one or more networks in communication with each other). The system environment 100 may have alternative configurations than shown in FIG. 1, including different, fewer, or additional components.

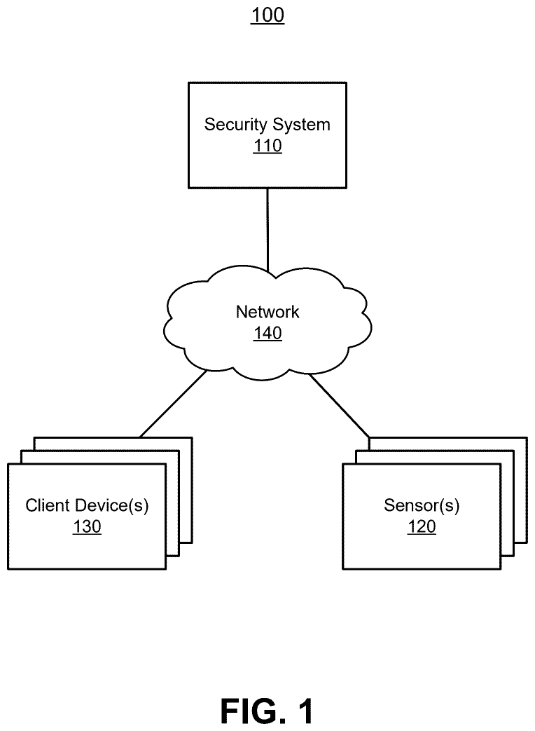

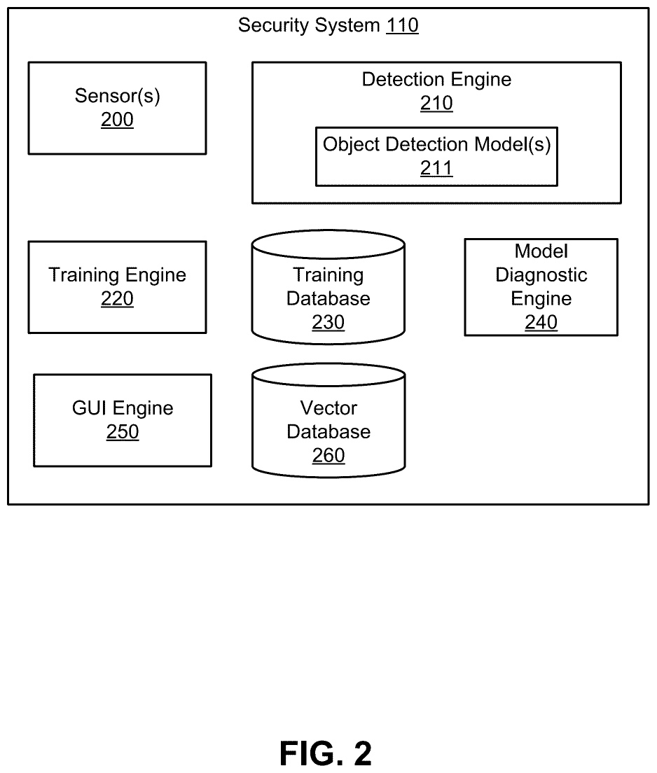

The security system 110 implements machine learning-driven object detection. The security system 110 may reside on a remote server communicatively coupled to the client device(s) 130. Although the security system 110 is depicted as remote from the client device(s) 130, in alternative embodiments, the security system 110 may reside on the client device(s) 130 and be executed from the client device(s) 130. Although the security system 110 is described as being applied to security uses, the machine learning-driven object detection of the security system 110 may be applied to non-security uses involving object detection. The security system 110 is described further with respect to the description of FIG. 2.

The sensor(s) 120 capture image data that may depict potential security threats. The sensor(s) 200 can include an imaging camera, infrared camera, depth camera, or any suitable optical sensor for capturing image data. The sensor(s) 120 may be co-located with other components of the security system 110 or located remotely (e.g., a camera located on a satellite that transmits the captured images to a ground-based remote server). The image data may include video or images. In some embodiments, the sensor(s) 120 may capture non-image data that may indicate a potential security threat. For example, the sensor(s) 120 may include a microphone that captures the noise from loading a firearm. The security system 110 may train a machine learning model to detect activity or objects from non-image data (e.g., a machine learning model trained to detect a firearm from noises caused from interacting with the firearm).

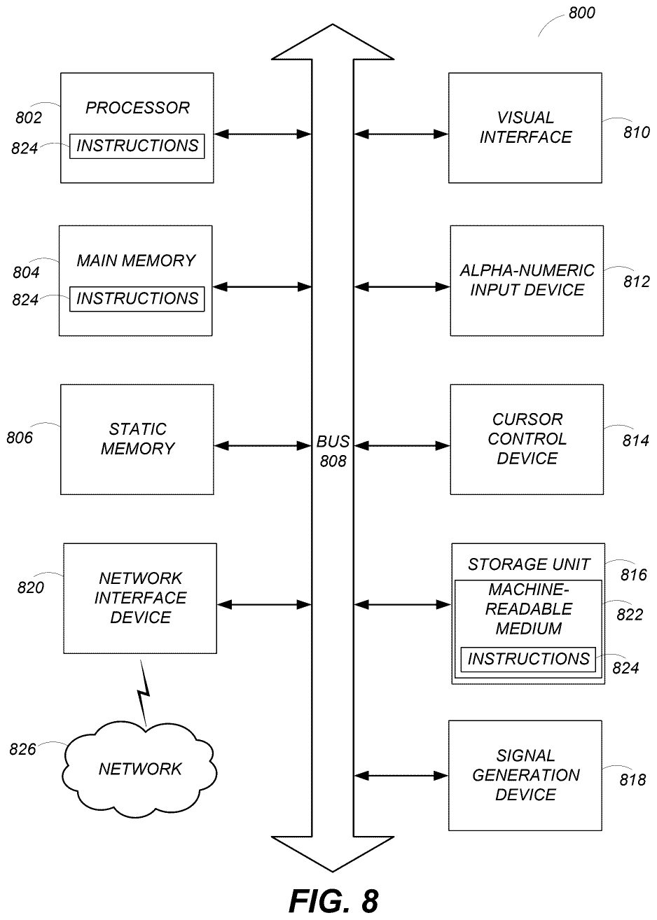

A client device, such as the client device(s) 130, may be a personal computer (PC), a tablet PC, a smartphone, or any suitable device capable of executing instructions that specify actions to be taken by that device. The client device(s) 130 may include some or all of the components of a computer system such as the computer system 800 described with FIG. 8.

The network 140 may serve to communicatively couple the security system 110, the sensor(s) 120, and the client device(s) 130. In some embodiments, the network 140 includes any combination of local area and/or wide area networks, using wired and/or wireless communication systems. The network 140 may use standard communications technologies and/or protocols. For example, the network 306 includes communication links using technologies such as Ethernet, 802.11, worldwide interoperability for microwave access (WiMAX), 3G, 4G, 5G, code division multiple access (CDMA), digital subscriber line (DSL), etc. Examples of networking protocols used for communicating via the network 306 include multiprotocol label switching (MPLS), transmission control protocol/Internet protocol (TCP/IP), hypertext transport protocol (HTTP), simple mail transfer protocol (SMTP), and file transfer protocol (FTP). Data exchanged over the network may be represented using any suitable format, such as hypertext markup language (HTML) or extensible markup language (XML). In some embodiments, all or some of the communication links of the network 140 may be encrypted using any suitable technique or techniques.

### Example Security System Configuration

FIG. 2 depicts a block diagram of the security system 110 of FIG. 1, in accordance with one embodiment. The security system 110 includes sensor(s) 200, a detection engine 210, object detection model(s) 211, a training engine 220, a training database 230, a model diagnostic engine 240, a graphical user interface (GUI) engine 250, and a vector database 260. The sensor(s) 200 may be similar to the sensor(s) 120. The detection engine 210, the training engine 220, the model diagnostic engine 240, and the GUI engine 250 may be software modules executed on a computer (e.g., a remote server or a client device) having some or all of the components computer system, for example, of the computer system 800 described with FIG. 8. The security system 110 may include additional, fewer, or different components than depicted in FIG. 2. For example, the sensor(s) 200 may be excluded from the security system 110 and instead, the security system 110 may be communicatively coupled to third party sensors. The security system 110 may be executed across two or more computer systems that are communicatively coupled with each other.

The detection engine 210 is configured to detect security threats within image data (e.g., images and videos). The detection engine 210 includes one or more object detection model(s) 211. The object detection model(s) 211 may be machine learning models. Example models used by the detection engine 210 include text classifiers, computer vision models, conversional neural networks, diagnostic models, transformers, autoencoders, or any suitable trained machine learning model. The object detection model(s) 211 may predict bounding boxes of one or more target objects depicted within an image input to the object detection model(s) 211. For example, given an image I, an object detection model 211 may predict bounding boxes according to Equation (1), where N is the number of detected objects. Equation (1) may be applied through YOLO V8. Although YOLO V8 is described with respect to calculations of equations described herein, any suitable object detection modeling algorithm may be used.

$$\begin{matrix}Equation ( Eq . ) & \\ {Boxes}_{Detection} = {\{ ( {x}_{min} , {y}_{min} , {x}_{max} , {y}_{max} ) \}}_{i = 1}^{N} & ( 1 )\end{matrix}$$

For an input image tensor, T, the detection engine 210 can generate a CAM using Equation (2), where M, is the model, L are the target layers, and T is the transformed image tensor. While Equation (2) may be applied through YOLO V8, the detection engine 210 may generate a CAM by computing the first principle component of 2D activations in a neural network without taking class discrimination into account.

$$CAM ( T ) = E igenCAM ( M , L , T ) \qquad Equation ( 2 )$$

If the CAM is multi-channel, the grayscale CAM can be delivered by averaging the channels. Let CAM(T) be a tensor with dimensions (C,H,W), where C is the number of channels and H and W are the height and width of the CAM. The grayscale CAM (GrayscaleCAM) can be obtained through Equation (3) via YOLO v8.

$$GrayscaleCAM ( x , y ) = \frac{1}{c} {\sum }_{c = 1}^{C} {CAM}_{C} ( T ) ( x , y ) \qquad Equation ( 3 )$$

where CAM_{c}(T) (x, y) is the activation value at position (x, y) in the c-th channel of the CAM, C is the number of channels in the CAM, and GrayscaleCAM(x, y) is the resulting grayscale activation value at position (x, y).

The training engine 220 is configured to train or re-train the object detection model(s) 211. The training engine 220 may train an object detection model 211 initially using a dataset of images of various classes corresponding to the target objects the images depict. The dataset of image of various classes may be a predefined (or predetermined) set. The dataset of images for training an object detection model 211 may be referred to as a labeled image dataset. The training engine 220 may train an object detection model 211 to detect one or more target objects within an image. The training engine 220 may re-train an object detection model 211 based on feedback indicating a metric of accuracy of the object detection model 211. The feedback may include an indication that the output of the model 211 is a false positive, a bounding box around the target object depicted in an image or video, or any suitable indication of a degree to which the output of the object detection model is accurate. The feedback may be user feedback or feedback through other channels such as automated artificial intelligence feedback.

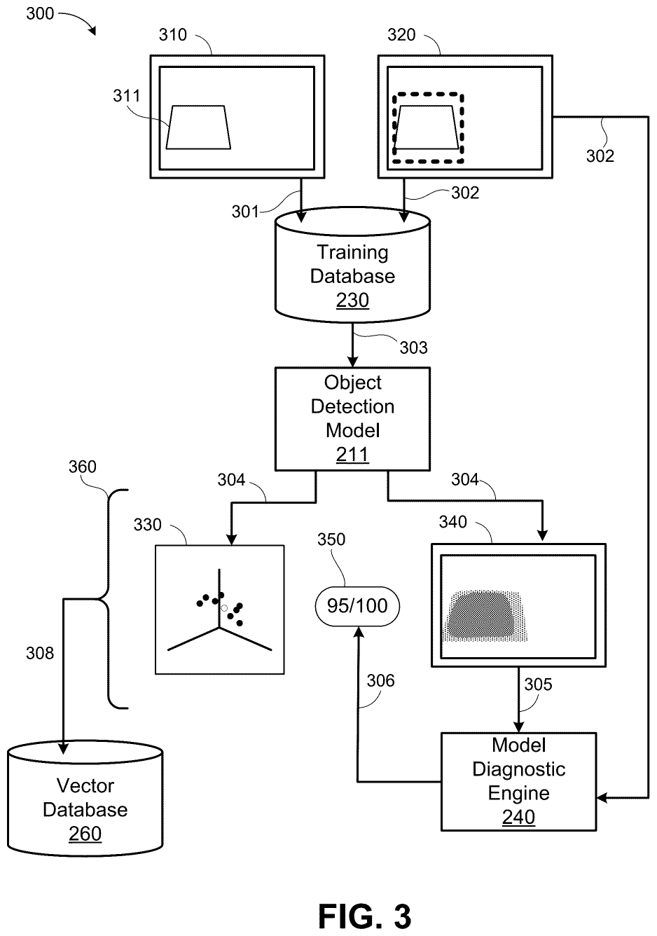

The training engine 220 may be configured to re-train an object detection model 211 using the vector database 260. After receiving feedback of an output of the object detection model 211, the training engine 220 may generate and store in the vector database 260 a data structure which can subsequently be used to re-train the object detection model 211. The data structure may include one or more inputs to the object detection model 211, an output of the object detection model 211, or feedback on the output. Alternatively, the data structure may include pointers to one or more of the one or more of an input to the object detection model 211, an output of the object detection model 211, or feedback on the output. For example, the training engine 220 generates the data structure including an embedding representative of an image input into the model 211, the image, a CAM, and a CAM score. The data structure may be indexed in the vector database 260 according to the embedding (i.e., the data structure may be queried from the vector database 260 using the embedding). One process of generating data structures by the training engine 220 is further described with respect to FIG. 3. The training engine 220 may store the generated data structure into the vector database 260. The data structure may also be used by the model diagnostic engine 240 to provide explanations of the detections determined by the object detection model(s) 211.

The training engine 220 also may be configured to receive training images provided from a source, e.g., images uploaded by a user, after the model diagnostic engine 240 has determined with which images to re-train an object detection model 211 and prompted the source to provide the images. For example, the model diagnostic engine 240 determines that images of a target object at different angles are needed to re-train an object detection model 211 and the training engine 220 receives the images to re-train the object detection model 211. This determination of which images to re-train a model is described further with respect to the model diagnostic engine 240.

The training engine 220 also may be configured to train a machine learning model based on one or more training algorithms. Examples of training algorithms may include mini-batch-based stochastic gradient descent (SGD), gradient boosted decision trees (GBDT), support vector machine (SVM), neural networks, logistic regression, naïve Bayes, memory-based learning, random forests, decision trees, bagged trees, boosted trees, or boosted stumps.

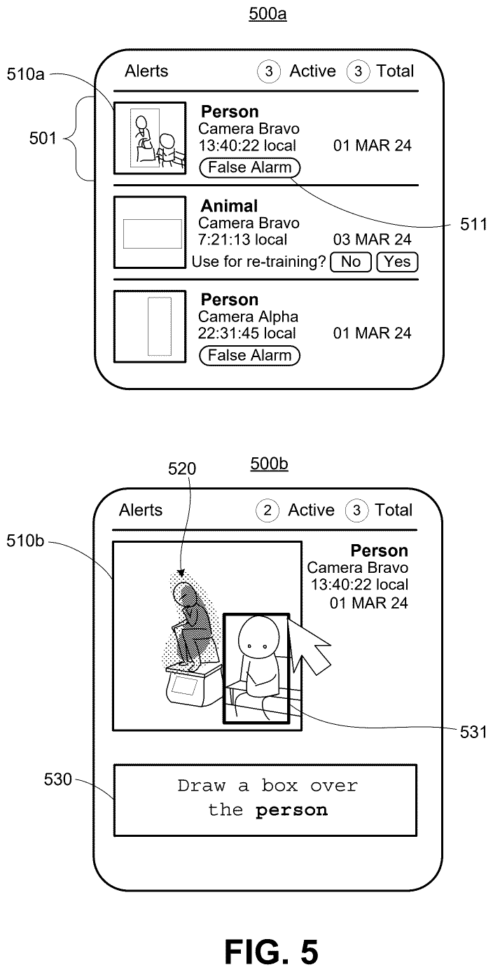

The training database 230 may be configured to store training datasets, image data transmitted by the sensor(s) 200, or user feedback received from the client device(s) 130. The graphical user interface (GUI) engine 250 may generate a GUI through which a user can receive notifications of object detections made by the security system 110 or can provide feedback on the accuracy of the object detections. The GUI engine 250 may update generated GUIs in response to user interactions. Examples of generating and updating GUIs are depicted in FIG. 5.

The model diagnostic engine 240 may be configured to assess the accuracy of the object detection model(s) 211 and also may be configured to determine recommendations for improving the accuracy. The model diagnostic engine 240 uses the CAM output by an object detection model 211 to assess the model's accuracy. The model diagnostic engine 240 receives user feedback on the output of the object detection model 211 and generates a CAM score using user feedback, where the CAM score represents a metric of accuracy of a given object detection model. The model diagnostic engine 240 determines a model score of the given object detection model using the determined CAM score.

If the security system 110 maintains multiple object detection models 211, the model diagnostic engine 240 uses the model score to compare the accuracy of one model to another. For example, if two of the object detection models 211 are trained to detect the same target object, the model diagnostic engine 240 may determine that one model is more accurately detecting the target object than the other and determine a higher model score for that model. The model diagnostic engine 240 may prompt the user, through the GUI engine 250, to provide particular training images to improve the accuracy of the object detection model whose model score is lower than the other or prompt the user, through the GUI engine 250, to use the object detection model with higher accuracy.

The model diagnostic engine 240 may be configured to provide explanations to a user if an object detection model 211 has detected a false positive of the target object. The model diagnostic engine 240 may receive user feedback indicating that a false positive was detected and in response, find training images that are most similar to the incorrectly identified target object. For example, if the target object was a traffic cone and the object detection model identified a cheer megaphone as a traffic cone, the model diagnostic engine 240 may find training images that appear to look more like a cheer megaphone. The model diagnostic engine 240 may find these training images by querying the vector database 260, which can include data structures indexed according to embeddings of input images.

The model diagnostic engine may be configured to determine embeddings of the vector database 260 within a threshold cosine distance of the embedding of the image input into the object detection model (e.g., the image of the cheer megaphone). The model diagnostic engine queries the vector database 260 using those embeddings, which are indexed to images in their respective data structures or pointers to those images. The model diagnostic engine 240 may cause the queried images to be displayed at a client device. The display of these similar images helps to explain why the output of the object detection model flagged an incorrect object as the target object (e.g., flagged a cheer megaphone instead of a traffic cone).

The model diagnostic engine 240 is configured to determine a CAM score based on a CAM and a bounding box around a target object depicted in an image. The model diagnostic engine 240 can determine, using the CAM, a set of pixels of the image satisfying a threshold contribution score, where the threshold contribution score indicates a level of contribution to the detection of the target object output by the object detection model. The model diagnostic engine 240 can determine internal pixels of the set of pixels and external pixels of the set of pixels. The internal pixels are pixels within the bounding box, which may include the pixels overlapping with the bounding box, and the external pixels are pixels located outside of the bounding box. The model diagnostic engine 240 can determine a CAM score based on a ratio of the internal pixels to the external pixels, a percentage of internal pixels to the total set of pixels, or any suitable metric of detection accuracy based on the bounding box. Additional methods for calculating CAM scores based on a combination of various scores (e.g., entropy, peak activation, and concentration scores) are also described herein.

The model diagnostic engine 240 may automatically determine the CAM score for an object detection model's output. An object detection model may be trained to output one or more predicted bounding boxes in an image, where each predicted bounding box captures a likely target object depicted in the image. The model diagnostic engine 240 may transform a CAM into grayscale for simplified visual representation in addition to reducing calculations needed to analyze the CAM relative to a colored CAM. The model diagnostic engine 240 may integrate multiple metrics to evaluate the quality and relevance of the CAMs for each predicted bounding box in the image.

The metrics may include a concentration score, peak activation score, and an entropy score. The concentration score may measure the density of activations within the predicted bounding boxes and providing sights into how well the model focuses on the objects of interest. The concentration score may be calculated using Equation (4), via YOLO V8, where N is the number of predicted bounding boxes and Box; is the i-th predicted bounding box.

$$Concentration = \frac{1}{N} {\sum }_{i = 1}^{N} \frac{{\sum }_{( x , y ) ϵ {Box}_{i}} GrayscaleCAM ( x , y )}{Area ( {Box}_{i} )} \qquad Equation ( 4 )$$

The peak activation score may combine global and focused peak activations, assessing the intensity and distribution of these activations. The peak activation score may be calculated using Equation (5), via YOLO V8, where Global_Peak=σ(GrayscaleCAM) and

$$Focused\_Peak = \frac{1}{N} {\sum }_{i = 1}^{N} σ ( {GrayscaleCAM}_{B o {x}_{i}} ) .$$

$$Peak\_Activation = ∝ \cdot Focused\_Peak + ( 1 - α ) \cdot Global\_Peak \qquad Equation ( 5 )$$

The entropy score may be calculated as a weighted average of global and focused entropy, capturing the uncertainty and spread of activations. The entropy score may be a weighted average of global and focused entropy as calculated by Equation (6), via YOLO V8, where

$$Global\_ Entropy = H ( GrayscaleCAM ) and Focused\_ Entropy = \frac{1}{N} {\sum }_{i = 1}^{N} H ( G r a y s {caleCAM}_{B o {x}_{i}} ) . Entropy = β \cdot Focused\_ Entropy + ( 1 - β ) \cdot Global\_Entropy \qquad Equation ( 6 )$$

By combining these scores with specific weights, the model diagnostic engine 240 may determine a CAM score that encapsulates the model's interpretability and reliability. This multifaceted evaluation enhances the transparency of the object detection model(s) 211 and provides a framework for comparing different models based on their ability to be explained, e.g., to a recipient, for example, a user. The CAM score maybe calculated by Equation (7), where ω_{c}, ωₚ, and ωₑ are the weights for concentration, peak activation, and entropy, respectively.

$$CAM\_SCore = {ω}_{c} \cdot Concentration + {ω}_{p} \cdot Peak\_Activation - {ω}_{e} \cdot Entropy \qquad Equation ( 7 )$$

The model diagnostic engine 240 may determine, after determining that a CAM score is lower than a threshold CAM score, one or more types of additional training images that would improve the accuracy of an object detection model whose outputs are producing the low CAM score. In one example, the model diagnostic engine 240 determines that a CAM score for an object detection model trained to detect motorcycles and bicycles has a higher CAM score for detecting motorcycles than for detecting bicycles. In response, the model diagnostic engine 240 causes, through the GUI engine 250, a prompt to be displayed at a client device requesting additional training images of bicycles. Additionally, the model diagnostic engine 240 can request that the additional training images be of bicycles at different angles, backgrounds, lighting, sizes, colors, any suitable variation in characteristic of depicting a bicycle (i.e., the target object), or a combination thereof.

In another example, the model diagnostic engine 240 determines that a CAM score for a first object detection model trained to detect motorcycles and bicycles is lower than a second object detection model also trained to detect motorcycles and bicycles. In response, the model diagnostic engine 240 causes, through the GUI engine 250, a prompt to be displayed at a client device recommending that the user switch to using the second object detection model instead of using the first object detection model.

The model diagnostic engine 240 determines a model score of the given object detection model using the determined CAM score. One example equation for calculating a model score is shown by Equations (8)-(12). The model diagnostic engine 240 can calculate individual average scores across multiple images. An average CAM score, average concentration score, average peak activation score, and average entropy score may be calculated by using Equations (8)-(11), respectively, where K is the number of images. The final model score is determined using Equation (12).

$${μ}_{CAM} = \frac{1}{K} {\sum }_{k = 1}^{K} {CAM\_Score}_{k} \qquad Equation ( 8 )$$

$${μ}_{C oncentration} = \frac{1}{K} {\sum }_{k = 1}^{K} {Concentration}_{k} \qquad Equation ( 9 )$$

$${μ}_{Peak \_ Activation} = \frac{1}{K} {\sum }_{k = 1}^{K} {Peak\_Activation}_{k} \qquad Equation ( 10 )$$

$${μ}_{Entropy} = \frac{1}{K} {\sum }_{k = 1}^{K} {Entropy}_{k} \qquad Equation ( 11 )$$

$$Model\_Score = ( {μ}_{CAM} , {μ}_{C oncentration} , {μ}_{Peak \_ Activation} , {μ}_{Entropy} ) \qquad Equation ( 12 )$$

The GUI engine 250 is configured to generate notifications at a client device indicating the operations of the security system 110. Examples of notifications can include object detections as output by the object detection model(s) 211, prompts requesting user feedback for the model diagnostic engine 240 to assess the accuracy of the object detection model(s) 211, prompts requesting additional training images (e.g., of different target objects or of the same target object at different angles), or recommendations, e.g., to the user, to use an object detection model that the system 110 has determined is more accurate.

The vector database 260 stores data for the model diagnostic engine 240 to assess the health of an object detection model 211, the training engine 220 to re-train a model, or a combination thereof. The vector database 260 may store previous object detection results of the security system 110 and corresponding determinations of the accuracy of those results. As described with respect to the training engine 220, the vector database 260 can store data structures indexed to an embedding output by an object detection model when determining whether a target object was depicted in an input image. Each data structure can include the embedding, the input image, a CAM associated with the input image, and a CAM score determined based on user feedback of the detection result. The data structure can additionally or alternatively include pointers to one or more of the embedding, input image, CAM, and CAM score. The vector database 260 can include multiple databases (e.g., a different database for different object detection models).

Referring now to FIG. 3, it shows a block diagram of an example process 300 for generating the vector database 260 of the security system 110 of FIG. 1, in accordance with one embodiment. The process 300 may include additional, fewer, or alternative operations than described in the description of FIG. 3. While components of the security system 110 are depicted in FIG. 3 as being executed from a remote server (i.e., separate from the client device(s) 130), one or more of the components may be located at and executed from the client device(s) 130.

During a training phase of the object detection model 211 prior to runtime, the security system 110 receives 301 an image 310 depicting a target object 311. The image 310 may be one of many images included within a dataset of images labeled according to classes of target objects that each image depicts. The image 310 is stored into the training database 230. The security system 110 receives 302 an image 320 that includes a bounding box around the target object 311. The image 320 may be stored in the training database 230. The training engine 220 accesses 303 a dataset of training images, including the image 310, and trains the object model 211. The object detection model 211 outputs 304 an embedding 330 and a CAM 340. The embedding 330 is representative of the image 310. The CAM 340 is a color-coded image (e.g., a heatmap) representing a degree to which each pixel of the image 310 contributes to the detection output by the object detection model 211.

The model diagnostic engine 240 accesses 305 the CAM 340 and receives 302 the image 320 to determine 306 a CAM score 350. For example, the CAM 340 includes a first subset of pixels that are color-coded in the darkest stippling to indicate that the first subset of pixels satisfies a first contribution threshold associated with pixels contributing the most to the detection of the target object 311. The CAM 340 includes a second subset of pixels that are color-coded in a lighter stippling to indicate that the second subset of pixels satisfies a second contribution threshold associated with pixels contributing to the detection of the target object 311, but not to the degree that the first subset of pixels contributes. The model diagnostic engine 240 determines, using the first and second subset of pixels and the bounding box of the image 320, that ninety-five percent of the first and second subset of pixels are within the bounding box. The CAM score 350 may reflect that percentage.

The training engine 220 is configured to generate a data structure 360 that includes the embedding 330, the CAM 340, and the CAM score 350. The training engine 220 stores 308 the data structure 360 into the vector database 260, where the data structure 360 can be indexed by the embedding 330 for querying. The training engine 220 may generate and store data structures for each of the training images in a training dataset, generating the vector database 260. The model diagnostic engine 240 may query training images from the vector database to provide explanations to a user (e.g., in response to the user indicating that the trained model has produced a false positive detection).

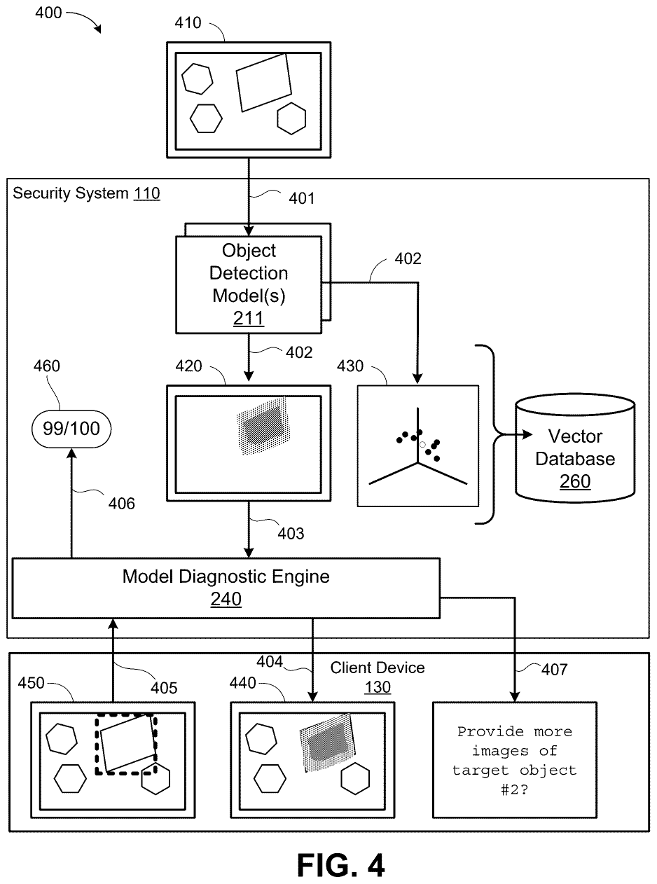

FIG. 4 depicts an example process 400 for determining to prompt a user for additional training data for the object detection model(s) 211 of FIG. 2, in accordance with one embodiment. The process 400 may be performed by the security system 110 during runtime of the object detection model(s) 211 in contrast with the process 300 which may be performed before runtime to train the object detection model(s) 211. The process 400 may include additional, fewer, or alternative operations than described in the description of FIG. 4. While components of the security system 110 are depicted in FIG. 4 as being executed from a remote server (i.e., separate from the client device(s) 130), one or more of the components may be located at and executed from the client device(s) 130.

The security system 110 receives 401 an image 410 from a source (e.g., from the sensor(s) 200). The detection engine 210 applies one of the object detection model(s) 211 to the image 410. One of the object detection model(s) 211 outputs 402 a CAM 420 and an embedding 430 associated with the image 410. The model is trained to identify two target objects, where the first target object is depicted in the image 410. The CAM 420 is depicted as a heatmap at the pixels corresponding to where the first target object is depicted in the image 410. The model diagnostic engine 240 receives 403 the CAM 420 and generates an overlay 440 of the image 410 with the CAM 420. The GUI engine 250, although not depicted, causes 404 a notification to be displayed at the client device 130, where the notification includes the overlay 440 and the corresponding detection result output from the object detection model(s) 211.

The GUI engine 250 may update the previously generated notification to allow the user to provide user feedback 450. The user may provide 405 to the model diagnostic engine 240 user feedback 450 on the accuracy of the object detection model's output, which includes a bounding box over the target object depicted in the image 410. The model diagnostic engine 240 determines 406 a CAM score 460. The training engine 220 generates a data structure with the CAM 420, the embedding 430, and the CAM score 460 and stores the data structure into the vector database 260. The model diagnostic engine 240 uses the CAM score 460 to evaluate the performance of the object detection model.

The model diagnostic engine 240 may determine to prompt 407, through the GUI engine 250, the user to provide more images of the second target object in response to determining that the average CAM score for the model's detection of the first target object is higher than the average CAM score for the model's detection of the second target object. In this way, the security system 110 uses the CAM score 460 to determine a specific instruction for the user to improve the accuracy of the object detection model.

FIG. 5 depicts example GUIs 500a and 500b that include notifications generated by the security system 110 of FIG. 1, in accordance with one embodiment. The GUIs 500a and 500b can be generated by the GUI engine 250. A notification generated by the GUI engine 250 may include a request for user feedback. The GUIs 500a and 500b may include additional, fewer, or different graphical display elements (e.g., buttons, scroller bars, tabs, text boxes, etc.). The GUIs 500a and 500b may be displayed at the client device(s) 130.

The GUI 500a depicts a notification 501. The notification 501 includes buttons for providing feedback to the security system 110 and an image 510a of the detected target object. The image 510a depicts a person sitting on a bench next to a statue. In the GUI 500a, a button 511 provides, when selected, feedback to the security system 110 that the detection of a person in the image taken by Camera Bravo was inaccurate (e.g., there was no person in the image or the detected “person” is not actually a person). While the button 511 may allow the user to indicate a metric of accuracy through a binary indicator (e.g., whether or not the detection was accurate or a false positive), alternatively, the metric of accuracy may be a range of values indicating a level of accuracy. The security system 110 has identified the statue as the target object (i.e., a person), where the identification is indicated in the image 510a by a rectangle around the identified target object.

The GUI 500b depicts an updated interface to the GUI 500a after the user has interacted with the notification 501. The GUI engine 250 may cause the GUI 500b to be displayed after receiving a user selection of the button 511, which can cause the GUI engine 250 display an enlarged image 510b of the detected target object, which is depicted with a CAM 520 overlaid on top of the detected target object. The CAM 520 is depicted over the statue because the security system 110 has incorrectly identified the person as the statue. The GUI engine 250 causes a prompt 530 to be displayed at the GUI 500b model diagnostic engine 240, where the prompt 530 instructs the user to draw a bounding box over the actual target object depicted, if any, in the image 510b. The user draws a bounding box 531 over the person sitting on the bench. The image and bounding box are provided to the security system 110 to calculate a CAM score associated with this detection. The CAM score calculated by the model diagnostic engine 240 reflects how very few, if any, pixels of the CAM 520 that meet a contribution threshold are within the bounding box 531.

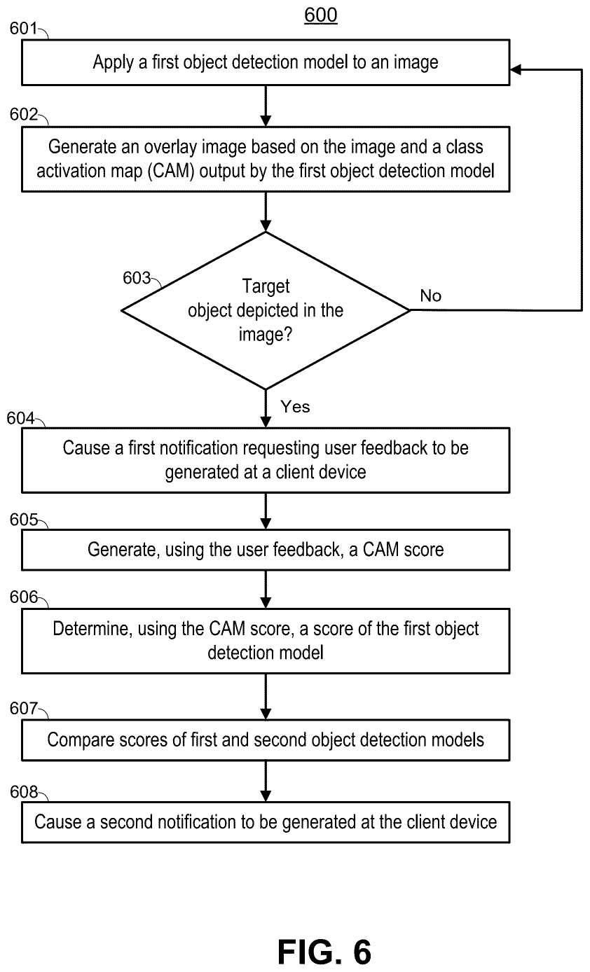

FIG. 6 depicts a flowchart of an example process 600 for selecting a model of the machine learning models of the security system 110 of FIG. 1, in accordance with one embodiment. Operations of the process 600 may be performed by the security system 110. The process 600 may include additional, fewer, or different operations than shown in FIG. 6. Operations of the process 600 may be performed in a different order than shown in FIG. 6 (e.g., in parallel rather than in series).

The security system 110 applies 601 a first object detection model to an image. The first object detection model is trained to detect a target object and output a CAM for the image. For example, the first object detection model is trained to detect firearms. The security system applies the first object detection model to an image of an office environment, which includes a stapler on top of a desk.

The security system 110 generates 602 an overlay image based on the image and a class activation map (CAM) output by the first object detection model. Following the previous example, the security system 110 may receive an output from the first object detection model that a firearm was detected in the image and receive a CAM showing a heatmap of which pixels in the image contributed above a contribution threshold to the determination that the firearm was detected. The security system 110 generates an overlay image of the CAM with the original image. In this example, the overlay may be a heatmap over the image of the office environment, where the hottest pixels are over the stapler.

The security system 110 determines 603 whether there is a target object depicted in the image. If there is no target object depicted, the security system 110 returns to applying 601 the first object detection model to an image (i.e., a subsequently received image). If there is a target object depicted, the security system 110 proceeds to causing 604 a first notification to be generated at a client device.

The security system 110 causes (e.g., through execution of program code) 604 a first notification requesting feedback, e.g., from a user, to be generated at a client device. The first notification includes the overlay image in addition to a request for user feedback representative of a first metric of accuracy of the first object detection model. The first metric of accuracy may include a bounding box. Following the previous example, the GUI engine 250 of the security system 110 causes a first notification to be generated at a client device, where the first notification shows the overlay image indicating a heatmap over the stapler in the image and indicates that a firearm was detected. The first notification can include a request for the user to draw a bounding box over the image where there is a firearm, if any. The user, because there is no firearm in the image, may provide user feedback omitting the bounding box and selecting a button generated by the GUI engine 250 that no firearm was detected.

The security system 110 generates 605, using the user feedback, a CAM score. The CAM score may be representative of a second metric of accuracy of the first object detection model. The security system 110 can generate a CAM score by determining a first subset of pixels of the CAM inside of a bounding box provided in the user feedback and a second subset of pixels of the CAM outside of the bounding box. The security system 110 can determine a ratio of the first and second subsets of pixels to determine the CAM score.

Following the previous example, the security system 110 can determine that all of the pixels are outside of the bounding box because no bounding box was provided in the user feedback, and the ratio may reflect a low CAM score.

The security system 110 determines 606, using the CAM score, a score of the first object detection model. The score may be an average of CAM scores, a weighted average of CAM scores, or any suitable metric using CAM scores for an object detection produced by the first object detection model. The security system 110 compares 607 scores of the first and second object detection models. Following the previous example, the security system 110 may determine a score for the first object detection model that captures the low CAM score calculated after the stapler false positive detection. The security system 110 may also be configured to determine that the score of the first object detection model is lower than a second object detection model. That is, the second object detection model has a higher accuracy for detecting firearms in images.

The security system 110 causes (e.g., through execution of program code) 608 a second notification to be generated at the client device. The second notification includes a recommendation to apply one of the first object detection model of the second object detection model based on the comparison. Following the previous example, the security system 110 determines a recommendation to apply a different object detection model trained to detect firearms instead of the first object detection model in response to determining that the score of the first model is lower than the second model. In this way, the security system 110 causes subsequent firearm detections to be more accurate, which reduces the risk of security threats caused by the presence of firearms.

Additionally, the security system 110 may query the vector database 260 for initial training and/or previous input runtime images used for training and cause or provide (e.g., through execution of program code) the queried images to be displayed at the second notification. Following the previous example, the security system 110 may query the vector database 260 using the embedding associated with the input image of a stapler. The model diagnostic engine 240 may determine other embeddings in the vector database 260 within a threshold distance of the embedding (e.g., based on cosine distances between pairs of embeddings) and access images in data structures indexed in the vector database 260 according to the other embeddings. By determining training images similar to the input image, the user has additional transparency as to how the model is reaching its detection decision. Moreover, the security system 110 may identify images to disregard for subsequent re-training of the model in response to the user indicating that the input image does not depict the target object for which the object detection model was trained to detect.

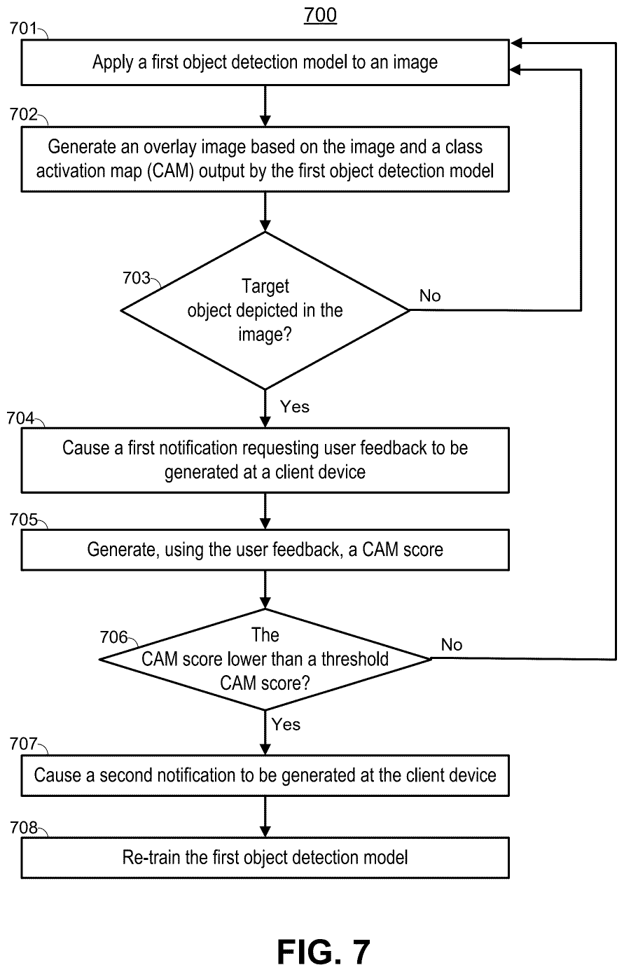

FIG. 7 depicts a flowchart of an example process 700 for re-training a machine learning model of the security system 110 of FIG. 1, in accordance with one embodiment. Operations of the process 700 may be performed by the security system 110. The process 700 may include additional, fewer, or different operations than shown in FIG. 7. Operations of the process 700 may be performed in a different order than shown in FIG. 7 (e.g., in parallel rather than in series).

The security system 110 applies 701 a first object detection model to an image. The first object detection model is trained to detect a target object and output a CAM for the image. The security system 110 generates 702 an overlay image based on the image and a CAM output by the first object detection model. The security system 110 determines 703 whether there is a target object depicted in the image. If there is no target object depicted, the security system 110 returns to applying 701 the first object detection model to an image (i.e., a subsequently received image). If there is a target object depicted, the security system 110 proceeds to causing 704 a first notification to be generated at a client device. The security system 110 causes (e.g., through execution of program code) 704 a first notification requesting feedback, e.g., from a user, to be generated at a client device. The first notification includes the overlay image in addition to a request for user feedback representative of a first metric of accuracy of the first object detection model. The first metric of accuracy may include a bounding box. The security system 110 generates 705, using the user feedback, a CAM score.

The security system 110 determines 706 whether the CAM score is lower than a threshold CAM score. The threshold CAM score may be user specified or automatically determined (e.g., based on a history of calculated CAM scores). In response to determining that the CAM score is not lower than the threshold CAM score, the security system 110 may return to applying 701 the first object detection model to a subsequently received image to determine if the target object is depicted in the subsequently received image. In response to determining that the CAM score is lower than the threshold CAM score, the security system 110 proceeds to cause 707 a second notification to be generated at the client device. The second notification may include a request for a training image or additional training image(s) of the target object depicted through a different photographic attribute than how the target object was depicted in the image applied to the first object detection model associated with the low CAM score. For example, the security system 110 instructs the user, via the second notification, to provide a training image of the target object depicted at a different angle than the target object was depicted in the image.

In some embodiments, the security system 110 may instruct the user to additionally, or alternatively, provide a training image of the target object depicted in a similar or same photographic attribute than how the target object was depicted in the image applied to the first object detection model. The security system 110 may have detected a false positive object detection in the image and in response, prompts for additional, similar training images to improve the accuracy of object detection in subsequent images with similar photographic attributes. For example, the security system 110 may prompt the user to provide a training image with the same level of brightness as depicted in an image that was associated with a low CAM score.

Example photographic attributes include the target object being depicted at a different angle, in a different background, through a different image display parameter (e.g., brightness, contrast, aspect ratio, etc.), in a different size, any suitable depiction difference for training the object detection model on a variation of the same target object, or a combination thereof. In some embodiments, the security system 110 may cause 707 the second notification to be generated as the request to provide the training image in addition to or as an alternative to a recommendation to apply a different object detection model as described in FIG. 6. The security system re-trains 708 the first object detection model using the training image received in response to causing 707 the second notification to be generated.

The processes 600 and 700 present example mechanisms by which the security system 110 improves the accuracy at which it detects objects in image data. This improvement reduces the likelihood of false positives being detected. In the previous example, detection of a stapler rather than a firearm is undesirable because a stapler does not pose the same level of threat as a firearm and thus, does not warrant the same response to ensure a person's safety (e.g., unnecessary defensive resources would be wasted to respond to the presence of a stapler).

Although the processes 600 and 700 describe two notifications, the security system 110 may cause fewer or less notifications to be displayed. Each notification may have components different from the two described with respect to the process 600. The notifications may be generated at different times (e.g., in parallel or in a different sequence). One or more generated notifications may include a GUI element to provide user feedback of the accuracy of an object detection model, images fetched from the vector database 260 explaining the object detection model's output, or a combination thereof.

### Computing Machine Architecture

FIG. 8 is a block diagram illustrating components of an example machine able to read instructions from a machine-readable medium and execute them in a processor (or controller). Specifically, FIG. 8 shows a diagrammatic representation of a machine in the example form of a computer system 800 within which program code (e.g., software) for causing the machine to perform any one or more of the methodologies discussed herein may be executed. The program code may be comprised of instructions 824 executable by a processor system 802 that may include one or more processors. In alternative embodiments, the machine operates as a standalone device or may be connected (e.g., networked) to other machines. In a networked deployment, the machine may operate in the capacity of a server machine or a client machine in a server-client network environment, or as a peer machine in a peer-to-peer (or distributed) network environment.

The machine may be a server computer, a client computer, a personal computer (PC), a tablet PC, a set-top box (STB), a personal digital assistant (PDA), a cellular telephone, a smartphone, a web appliance, a network router, switch or bridge, or any machine capable of executing instructions 824 (sequential or otherwise) that specify actions to be taken by that machine. Further, while only a single machine is illustrated, the term “machine” shall also be taken to include any collection of machines that individually or jointly execute instructions 824 to perform any one or more of the methodologies discussed herein.

The example computer system 800 includes a processor system 802. The processor system includes one or more processors, e.g., a central processing unit (CPU), a graphics processing unit (GPU), a neural processing unit (NPU), a tensor processing unit (TPU), a digital signal processor (DSP), one or more application specific integrated circuits (ASICs), one or more radio-frequency integrated circuits (RFICs), or any combination of these. The processor system 802 executes an operating system for the computer system700. The computer system 800 also may include a main memory 804, and a static memory 806, which are configured to communicate with each other via a bus 808. The computer system 800 may further include visual display interface 810. The visual interface may include a software driver that enables displaying user interfaces on a screen (or display). The visual interface may display user interfaces directly (e.g., on the screen) or indirectly on a surface, window, or the like (e.g., via a visual projection unit). For ease of discussion the visual interface may be described as a screen. The visual interface 810 may include or may interface with a touch enabled screen. The computer system 800 may also include alphanumeric input device 812 (e.g., a keyboard or touch screen keyboard), a cursor control device 814 (e.g., a mouse, a trackball, a joystick, a motion sensor, or other pointing instrument), a storage unit 816, a signal generation device 818 (e.g., a speaker), and a network interface device 820, which also are configured to communicate via the bus 808.

The storage unit 816 includes a machine-readable medium 822 on which is stored instructions 824 (e.g., software) embodying any one or more of the methodologies or functions described herein. The instructions 824 (e.g., software) may also reside, completely or at least partially, within the main memory 804 or within the processor system 802 (e.g., within a processor's cache memory) during execution thereof by the computer system 800, the main memory 804 and the processor system 802 also constituting machine-readable media. The instructions 824 (e.g., software) may be transmitted or received over a network 826 via the network interface device 820.

While machine-readable medium 822 is shown in an example embodiment to be a single medium, the term “machine-readable medium” should be taken to include a single medium or multiple media (e.g., a centralized or distributed database, or associated caches and servers) able to store instructions (e.g., instructions 824). The term “machine-readable medium” shall also be taken to include any medium that is capable of storing instructions (e.g., instructions 824) for execution by the machine and that cause the machine to perform any one or more of the methodologies disclosed herein. The term “machine-readable medium” includes, but not be limited to, data repositories in the form of solid-state memories, optical media, and magnetic media.

### Benefits and Additional Considerations

The security system improves the accuracy of machine learning-driven object detection and in turn, decreases the risk of safety threats to individuals or property. The security system leverages class activation mapping and generates an overlay of a CAM on an image that depicts a detected target object. While the CAM overlay assists the user in understanding the machine learning model's detection, the security system provides additional explanation in the form of one or more training images used to train the model that are similar to the input image. The security system generates a vector database that include training images indexed by embeddings representative of those images. The embedding index allows the security system to determine similar images (e.g., by using cosine distances among embedding pairs). The training images show the user what the model was trained on to make the object detection determination, which may help explain false positive detections. By providing a CAM overlay and/or training images, the security system provides explainable false positives for machine learning-driven object detection.

The security system can increase the accuracy of the object detections output by the machine learning model by determining one or more particular types of training images that are likely to improve the model's output accuracy. The security system uses a CAM score determined based on user feedback to determine whether additional training images are for a particular target object for which an object detection model is trained to detect. If the CAM score indicates additional training images likely improve the model's accuracy, the security system may prompt the user with instructions on which types of images to provide for re-training (e.g., images of a target object in a background in which the target object blends in and that the model is presently having difficulty accurately detecting the object). By narrowly tailoring the types of images for re-training, the security system improves the efficiency at which the system is re-trained to detect target objects whose detection accuracy is lower than the model's detection accuracy for other objects.

Additionally, the security system may improve the accuracy of machine learning-driven object detection by determining which of multiple models trained to detect a given target object is more accurate. The security system can leverage the CAM score to score various object detection models' accuracies and make a recommendation to a user to implement a more accurate model. Alternatively, the security system can automatically switch from using a less accurate model to a more accurate model.

The CAM score is beneficial during the data labeling process as it helps create better training datasets. By visualizing the regions that an object detection model focuses on, users can more accurately label data and help ensure that the training dataset is representative of important features the model should learn. This leads to high-quality annotations and ultimately improves object detection model performance.

During the model training process, the CAM score approach allows for real-time or substantially real-time feedback on how well a model is learning to identify and focus on relevant objects. By analyzing the CAMs and their associated scores, the training process can include fine-tuning a model's architecture and training parameters to enhance its focus and reduce uncertainty, leading to more robust and accurate models.

At inference, the CAM score approach can provide clear and interpretable explanations for the model's predictions and alerts. When a model raises an alert, the CAMs can visually demonstrate why the model made that decision, showing the specific regions in the input data that influenced that prediction. This transparency can be crucial for building trust in artificial intelligence systems, especially in critical applications such as security and frontline perception systems, where understanding the rationale behind alerts can significantly impact decision-making and response strategies.

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Throughout this specification, some embodiments have used the expression “coupled” along with its derivatives. The term “coupled” is not necessarily limited to two or more elements being in direct physical or electrical contact. Rather, the term “coupled” may also encompass two or more elements that are not in direct contact with each other, but yet still co-operate or interact with each other.

The terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the invention. This description should be read to include one or at least one and the singular also includes the plural unless it is obvious that it is meant otherwise. Where values are described as “approximate” or “substantially” (or their derivatives), such values should be construed as accurate +/−10% unless another meaning is apparent from the context. From example, “approximately ten” should be understood to mean “in a range from nine to eleven.”

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability. Any computing systems including multiple processors may operate the multiple processors individually or collectively.

Embodiments may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the disclosed subject matter. It is therefore intended that the scope be limited not by this detailed description, but rather by any claims that issue on an application based hereon. Accordingly, the disclosure of the embodiments are intended to be illustrative, but not limiting, of the scope, which is set forth in the following claims.

What is claimed is:

1. A non-transitory computer-readable storage medium comprising stored instructions, the instructions when executed by a computing system cause the computing system to:
apply a first object detection model to an image, where the first object detection model is trained to detect a target object and output a class activation map (CAM) for the image;
generate an overlay image based on the CAM and the image;
responsive to a determination that the target object is depicted in the image, cause a first notification to be generated at a client device, the first notification including the overlay image and a request for feedback representative of a first metric of accuracy of the first object detection model;
generate, using the feedback, a CAM score representative of a second metric of accuracy of the first object detection model;
determine a model score of the first object detection model using the CAM score;
executing a comparison of the model score of the first object detection model to a model score of a second object detection model trained to detect the target object; and
generate a second notification for the client device, the second notification including a recommendation to apply one of the first object detection model or second object detection model based on the comparison.

2. The non-transitory computer-readable storage medium of claim 1, wherein the instructions further comprise instructions that when executed by the computing system cause the computing system to:
generate a data structure including an embedding representative of the image, the image, CAM, and the CAM score, wherein the first object detection model is trained to further output the embedding;
store the data structure in a vector database, wherein the data structure is indexed in the vector database using the embedding; and
re-train the first object detection model using the vector database.

3. The non-transitory computer-readable storage medium of claim 2, wherein the instructions further comprise instructions that when executed by the computing system cause the computing system to:
responsive to a determination that the feedback indicates the target object detected by the first object detection model in the image is a false positive:
determine one or more embeddings of the vector database within a threshold cosine distance of the embedding;
query the vector database using the one or more embeddings, the one or more embeddings indexed to respective images; and
cause the images to be displayed at the client device.

4. The non-transitory computer-readable storage medium of claim 1, wherein the feedback indicates a bounding box over the target object depicted in the image, wherein the instructions to generate, using the feedback, the CAM score comprise instructions that when executed by the computing system cause the computing system to:
determine, using the CAM, a set of pixels of the image satisfying a contribution threshold to the detection of the target object output by the first object detection model;
determine internal pixels of the set of pixels, the internal pixels located within the bounding box;
determine external pixels of the set of pixels, the external pixels located outside of the bounding box; and
determine the CAM score based on a ratio of the internal pixels to the external pixels.

5. The non-transitory computer-readable storage medium of claim 1, wherein the instructions to determine the model score comprise instructions that when executed by the computing system cause the computing system to:
determine a weighted average of the CAM score and previously generated CAM scores for the first object detection model, wherein the previously generated CAM scores indicate respective metrics of accuracy of the first object detection model for detecting the target object.

6. The non-transitory computer-readable storage medium of claim 1, wherein the instructions further comprise instructions that when executed by the computing system cause the computing system to:
responsive to a determination that the CAM score is lower than a threshold CAM score, cause a third notification to be generated at the client device, the third notification including a request for a training image of the target object at an angle different from a depicted angle of the target object in the image; and
re-train the first object detection model using the training image.

7. The non-transitory computer-readable storage medium of claim 1, wherein the target object is a first target object, wherein the first object detection model is trained to further detect a second target object, wherein the instructions further comprise instructions that when executed by the computing system cause the computing system to:
responsive to a determination that the CAM score for detecting the first target object is higher than a CAM score for detecting the second target object using the first object detection model, cause a third notification to be generated at the client device, the third notification including a request for a training image of the second target object; and
re-train the first object detection model using the training image.

8. The non-transitory computer-readable storage medium of claim 1, wherein the instructions further comprise instructions that when executed by the computing system cause the computing system to:
receive a labeled image dataset;
train the first object detection model using the labeled image dataset;
receive as output from the first object detection model an embedding representative of a labeled image in the labeled image dataset image and a CAM of the labeled image;
generate a CAM score associated with the CAM; and
store in a vector database a data structure comprising the CAM of the labeled image and the CAM score, the data structure indexed to the embedding.

9. A computer system comprising:
a detection engine configured to:
apply a first object detection model to an image, where the first object detection model is trained to detect a target object and output a class activation map (CAM) for the image;
a model diagnostic engine configured to:
generate an overlay image based on the CAM and the image; and
a GUI engine configured to:
responsive to a determination that the target object is depicted in the image, cause a first notification to be generated at a client device, the first notification including the overlay image and a request for user feedback representative of a first metric of accuracy of the first object detection model;
wherein the model diagnostic engine is further configured to:
generate, using the user feedback, a CAM score representative of a second metric of accuracy of the first object detection model,
determine a model score of the first object detection model using the CAM score, and
execute a comparison of the model score of the first object detection model to a model score of a second object detection model trained to detect the target object; and
wherein the GUI engine is further configured to:
cause a second notification to be generated at the client device, the second notification including a recommendation to apply one of the first object detection model or second object detection model based on the comparison.

10. The computer system of claim 9, wherein the computer system further comprises a training engine configured to:
generate a data structure including an embedding representative of the image, the image, CAM, and the CAM score, wherein the first object detection model is trained to further output the embedding;
store the data structure in a vector database, wherein the data structure is indexed in the vector database using the embedding; and
re-train the first object detection model using the vector database.

11. The computer system of claim 10, wherein the model diagnostic engine is further configured to:
responsive to a determination that the user feedback indicates the target object detected by the first object detection model in the image is a false positive:
determine one or more embeddings of the vector database within a threshold cosine distance of the embedding;
query the vector database using the one or more embeddings, the one or more embeddings indexed to respective images; and
cause the images to be displayed at the client device.

12. The computer system of claim 9, wherein the user feedback indicates a bounding box over the target object depicted in the image, wherein the model diagnostic engine is further configured to:
determine, using the CAM, a set of pixels of the image satisfying a contribution threshold to the detection of the target object output by the first object detection model;
determine internal pixels of the set of pixels, the internal pixels located within the bounding box;
determine external pixels of the set of pixels, the external pixels located outside of the bounding box; and
determine the CAM score based on a ratio of the internal pixels to the external pixels.

13. The computer system of claim 9, wherein
the GUI engine is further configured to:
responsive to a determination that the CAM score is lower than a threshold CAM score, cause a third notification to be generated at the client device, the third notification including a request for a training image of the target object at an angle different from a depicted angle of the target object in the image; and
the model diagnostic engine is further configured to:
re-train the first object detection model using the training image.

14. The computer system of claim 9, wherein the target object is a first target object, the first object detection model is trained to further detect a second target object, and wherein:
the GUI engine is further configured to:
responsive to a determination that the CAM score for detecting the first target object is higher than a CAM score for detecting the second target object using the first object detection model, cause a third notification to be generated at the client device, the third notification including a request for a training image of the second target object; and
the model diagnostic engine is further configured to:
re-train the first object detection model using the training image.

15. A method comprising:
applying a first object detection model to an image, where the first object detection model is trained to detect a target object and output a class activation map (CAM) for the image;
generating an overlay image based on the CAM and the image;
responsive to a determination that the target object is depicted in the image, causing a first notification to be generated at a client device, the first notification including the overlay image and a request for user feedback representative of a first metric of accuracy of the first object detection model;
generating, using the user feedback, a CAM score representative of a second metric of accuracy of the first object detection model;
responsive to determining that the CAM score is lower than a threshold CAM score, causing a second notification to be generated at the client device, the second notification including a request for a training image of the target object depicted through a different photographic attribute than a depiction of the target object in the image; and
re-training the first object detection model using the training image.

16. The method of claim 15, further comprising:
generating a data structure including an embedding representative of the image, the image, CAM, and the CAM score, wherein the first object detection model is trained to further output the embedding;
storing the data structure in a vector database, wherein the data structure is indexed in the vector database using the embedding; and
re-training the first object detection model using the vector database.

17. The method of claim 16, further comprising:
responsive to determining that the feedback indicates the target object detected by the first object detection model in the image is a false positive:
determining one or more embeddings of the vector database within a threshold cosine distance of the embedding;
querying the vector database using the one or more embeddings, the one or more embeddings indexed to respective images; and
causing the images to be displayed at the client device.

18. The method of claim 15, wherein the feedback indicates a bounding box over the target object depicted in the image, wherein generating, using the feedback, the CAM score comprises:
determining, using the CAM, a set of pixels of the image satisfying a contribution threshold to the detection of the target object output by the first object detection model;
determining internal pixels of the set of pixels, the internal pixels located within the bounding box;
determining external pixels of the set of pixels, the external pixels located outside of the bounding box; and
determining the CAM score based on a ratio of the internal pixels to the external pixels.

19. The method of claim 15, further comprising:
determining a model score of the first object detection model using the CAM score;
executing a comparison of the model score of the first object detection model to a model score of a second object detection model trained to detect the target object; and
causing a third notification to be generated at the client device, the third notification including a recommendation to apply one of the first object detection model or second object detection model based on the comparison.

20. The method of claim 15, wherein the target object is a first target object, wherein the first object detection model is trained to further detect a second target object, further comprising:
responsive to determining that the CAM score for detecting the first target object is higher than a CAM score for detecting the second target object using the first object detection model, causing a third notification to be generated at the client device, the third notification including a request for a training image of the second target object; and
re-training the first object detection model using the training image of the second target object.
